(19) United States
(12) Patent Application Publication
(10) Pub. No.: US 2013/0100805 A1
(43) Pub. Date: Apr. 25, 2013

(54) PRIORITIZED TRANSFER OF DATA TELEGRAMS

(71) Applicants: Holger Heine, Berlin (DE); Stephan Jorra, Glienicke (DE); Harald Kapp, Berlin (DE)

(72) Inventors: Holger Heine, Berlin (DE); Stephan Jorra, Glienicke (DE); Harald Kapp, Berlin (DE)

(73) Assignee: SIEMENS AKTIENGESELLSCHAFT, MUENCHEN (DE)

(21) Appl. No.: 13/806,504

(22) PCT Filed: Jun. 25, 2010
(86) PCT No.: PCT/EP2010/059053

§ 371 Date: Dec. 21, 2012

(51) Int. Cl. H04L 12/56

(52) U.S. Cl. CPC H04L 47/24
USPC 370/230

(57) ABSTRACT

Data telegrams are transmitted from a transmitter to a receiver. A priority level is associated with the data telegrams that specifies a priority to be considered for the transfer of the particular data telegram. In order to transfer data telegrams having different priority levels with relatively less effort and thus even more quickly, an intermediate storage area is associated with each priority level in the transmitter, the data telegrams are transferred over the physical communication medium by different logical data connections, whose number corresponds with the number of priority levels. Lower priority data telegrams in the intermediate storage area are transferred by way of the logical data connection associated with the priority level until at least one higher priority data telegram is present in the intermediate storage area. The higher priority data telegram in the intermediate storage area is transmitted through a logical data connection with the higher priority level.

The invention relates to a method for transmitting data telegrams from a transmitter to at least one receiver, in which a priority level is allocated to the data telegrams to be transmitted, which level specifies a priority to be taken into consideration in the transmission of the respective data telegram in such a manner that data telegrams having a higher priority level compared with those having a lower priority level are transmitted preferably by the transmitter, via a physical communication medium connected both to the transmitter and to the receiver, to the receiver. In addition, the invention relates also to a corresponding electrical device which is arranged for transmitting data telegrams.

In the transmission of data telegrams between electrical devices, delays may occur in the data transmission due to the limited transmission bandwidth of a physical transmission medium existing between the electrical devices. Such delays have a critical effect particularly when data telegrams having a very important data content or one which is to be transmitted within a short time are affected by this, whereas other data telegrams, the data content of which is less important and/or allows transmission over a longer period, are less strongly affected by this.

The transmission of data having different importance can be of significance in very different scenarios, as will be explained by means of the examples following:

According to a first example, a transmission of different data telegrams takes place via a communication network, operating in accordance with the IP protocol, of a home or office network with Internet connection. In this context, e.g. data telegrams may occur which contain parts of a file which has been requested in a downloading process by a terminal connected to the communication network and in which the duration of transmission often plays a subordinate role. Besides this, however, data telegrams may be transmitted via the same communication network which are used for the purpose of conveying a feature film to a player in accordance with a so-called “video-on-demand” service; such data telegrams must be transmitted as quickly and completely as possible via the communication network in order to avoid picture disturbances and/or disproportionately long loading interruptions.

According to another example, data telegrams are to be transmitted between individual automation devices of an energy automation system. In this context, the content of the data telegrams can be, for example, so-called interference records—that is to say measurement value traces recorded during a disturbance for later analysis, which are to be transmitted from an electrical field device to a network control center. This transmission must be considered to be non-time-critical. However, via the same physical communication medium, messages signifying a current fault and/or measurement values and/or control commands to be evaluated over a short time must be transmitted between the automation devices of the energy automation system which must arrive within a short time at the respective receiver, since the automation system has to respond within as short as possible a time and, therefore, delay in the transmission of data telegrams having corresponding contents cannot be tolerated.

To avoid such delays in the transmission of data telegrams having a critical content, it has been chosen to allocate individual priority levels to the data telegrams which specify the priority with which a data telegram is to be treated by the respective transmitters and receivers in a data transmission system. It is thus provided, e.g. that transmitters and/or receivers preferably transmit data telegrams having a higher priority level, whereas the transmission of data telegrams having a lower priority level are held back in favor of the data telegrams with higher priority. This process, also known by the collective term “quality of service”, has the disadvantage, however, that it requires an examination of the data telegrams for a marker specifying the priority levels, a so-called “flag”, on a relatively high layer of the OSI layer model set up for the data communication so that the individual devices which are involved in the data transmission must first perform an analysis of the data telegram in order to determine its priority level and then to treat the data telegram preferably in accordance with the priority level determined or to hold it back in favor of other data telegrams.

The invention is based on the object, therefore, of specifying a method of the type initially specified in which the transmission of data telegrams having different priority levels can be performed with relatively less effort and, as a result, even quicker. A further object consists in specifying correspondingly arranged transmitters and receivers.

To achieve this object, a method of the type initially specified is developed, according to the invention, in such a manner that in the transmitter, an intermediate storage area is allocated to each priority level, the data telegrams are transmitted via the physical communication medium via different logical data links, the number of logical data links corresponding to the number of priority levels, data telegrams present in an intermediate storage area allocated to a lower priority level are transmitted via the logical data link allocated to this priority level for such a time until at least one data telegram is present in an intermediate storage area allocated to a higher priority level and the data telegram present in the intermediate storage area allocated to the higher priority level is transmitted via the logical data link allocated to the higher priority level.

Among other things, it is considered to be advantageous in the method according to the invention that the communication of the data telegrams is performed via the same physical communication medium in mutually separate logical data links, a priority level being permanently allocated to each logical data link. The physical communication medium can be, e.g., a wire-connected medium, that is to say, for example, a copper line, a coaxial line or an optical fiber line, or a wireless communication link, for example radio link. The transmission of data telegrams can take place, for example, in accordance with an Ethernet protocol, a Profibus protocol or other communication protocols. In this connection, a logical data link is understood to be virtually a transmission channel separately set up via a physical communication medium which defines a separate data link between the transmitter and the receiver in accordance with the communication protocol used. For example, a separate logical address (e.g. a MAC address (Media Access Control) or a special device address) of the receiver can be allocated to each logical data link for this purpose.

Using individual logical data links and permanently allocating in each case one priority level to one such logical data link ensures that the respective priority level of a data telegram can be recognized already on the lowest layer of the OSI layer model without having to perform a thorough analysis of the content of the data telegram. By allocating individual intermediate storage areas to the priority levels—and thus also to the logical data links—each logical data link is fed, as it were, with data telegrams of the same priority level from a separate source.

As long as only data telegrams are present in the intermediate storage area of a lower priority level, these data telegrams are successively transmitted via the corresponding logical data link to the receiver. However, as soon as a data telegram is present in an intermediate storage area of a higher priority level, this data telegram is transmitted via the corresponding logical data link whilst the transmission of the data telegrams of the lower priority level is stopped.

It is especially when a data transmission of the individual data telegrams does not take place directly from a transmitter to the final receiver, but the transmission of the data telegrams takes place in several transmission sections with interposition of several devices (e.g. routers), that the method according to the invention offers distinct advantages with respect to the known procedure, since no analysis of the content of the data telegram needs to be performed after a flag specifying the priority level, but the priority level of the respective data telegram is specified unambiguously by the selected logical data link alone. During the forwarding of a received data telegram, the data telegram only needs to be transmitted onward on a logical data link of the corresponding priority level. In other words, unambiguous “high-speed roads” are set up for data telegrams having a high priority level via the same physical communication medium so that a high-priority data telegram is transmitted continuously on the high-speed road corresponding to its priority level during the complete transmission from the original sender to the final receiver.

The method according to the invention is suitable both for the transmission of data telegrams from a transmitter to a receiver and for the transmission of data telegrams from a transmitter to a number of receivers.

An advantageous development of the method according to the invention provides that the current transmission of a data telegram via the logical data link allocated to the lower priority level is aborted as soon as a data telegram is present in the intermediate storage area allocated to the higher priority level. This makes it possible to ensure that the transmission of a higher-priority data telegram takes place in each case immediately after its deposition in the corresponding intermediate storage area of the higher priority level and any transmission of low-priority data telegrams still pending is immediately aborted.

In this connection it is considered to be advantageous if an identification which marks the data telegram as to be discarded by the receiver is added to the data telegram transmitted incompletely due to the termination of transmission.

In this manner, the receiver can be informed quite simply that the transmission of the corresponding low-priority data telegram has been aborted incompletely and the data telegram correspondingly cannot be processed further. This offers an advantage especially if the data telegram transmitted incompletely was to be forwarded to other devices by the receiver and loading of the subsequent communication medium would have been created unnecessarily by an incomplete—and thus useless—data telegram.

In this connection, a further embodiment provides that the transmission of the data telegram transmitted incompletely is repeated after the last data telegram currently present in the intermediate storage area allocated to the higher priority level has been transmitted. This makes it possible to ensure that even a data telegram transmitted incompletely is not lost but is transmitted again after the transmission of the data telegram with the higher priority in each case.

As an alternative to an abortion of the transmission of the low-priority data telegram, however, it can also be provided that the current transmission of a data telegram via the logical data link allocated to the lower priority level is first concluded before the data telegram present in the intermediate storage area allocated to the higher priority level is transmitted via the logical data link allocated to the higher priority level.

In this embodiment, the transmission currently taking place, of a data telegram having a lower priority level, is concluded completely even when there is already a data telegram of a higher priority level present in the corresponding intermediate storage area. In this embodiment, a slight delay of the data telegrams with higher priority is deliberately accepted in order to avoid, for example, additional effort in the repeated transmission of an incompletely transmitted data telegram.

An advantageous embodiment of the method according to the invention also provides that the priority level for the respective data telegram is specified by means of a destination address used for the receiver.

In this manner, the priority level of the respective data telegram can be specified in a particularly simple manner, namely by using a destination address allocated to the corresponding logical data link in the receiver as destination address of the respective data telegram. In consequence, no identifications of the data telegrams going beyond the destination address need to be performed.

A further advantageous embodiment provides in this connection that the destination addresses used for the different priority levels are determined in accordance with a specified rule so that, knowing a destination address which is allocated to a particular priority level, all destination addresses of the remaining priority levels can be derived from the known destination address.

By this means, a transmitter, knowing a single destination address allocated to a particular priority level of the receiver, can determine all other destination addresses of the receiver allocated to the remaining priority levels, since the transmitter knows the rule according to which the destination addresses are formed for the individual priority levels and thus a derivation of the unknown destination addresses from the known destination address is possible.

A further advantageous embodiment of the method according to the invention provides that for the start-up of a system of at least one transmitter and at least one receiver, at least one of the devices sends a broadcast message to a destination address defined throughout the system, this destination address defined throughout the system being allocated to a particular priority level, and a device receiving this broadcast message takes a sender address, specifying the sender of the broadcast message, from the broadcast message and uses this sender address from then on as destination address for this priority level, allocated to the sender.

In this manner, starting up especially a system having a number of transmitters and/or receivers can be distinctly simplified in that a defined destination address is provided throughout the system (that is to say uniformly for all devices involved)—for example the MAC address “0xFFFFFFFFFFFF”—to which a so-called broadcast message, that is to say a data telegram which is directed to all devices connected to the physical communication medium, is sent.

A particular priority level is allocated to the destination address defined so that the devices receiving this broadcast message can use from then on, for the data transmission of data telegrams of this priority level to the sender of the broadcast message, its sender address as destination address. If, in this case, the individual destination addresses of the respective priority levels are additionally dependent on one another in accordance with a specified rule as described before, all other destination addresses of the corresponding sender device can be determined by means of this one broadcast message for the respective priority levels.

To achieve the abovementioned object, an electrical device comprising a communication interface for establishing a communication link via a physical communication medium to at least one further electrical device is proposed, the physical communication medium being arranged for transmitting data telegrams between the devices. According to the invention, it is provided in this context that the communication interface is arranged for establishing at least two logical data links via the physical communication medium, a different priority level being allocated to each logical data link, and the electrical device is arranged for transmitting the data telegrams in accordance with a method according to one of claims 1 to 8 previously explained.

It is also considered to be particularly advantageous if the electrical device is an automation device of an energy automation system, preferably an electrical protective device, an electrical field control unit, a station control unit, a device of an electrical power system control center or a communication device used in an energy automation system.

In the text which follows, the invention will be explained in greater detail with reference to exemplary embodiments. In reference to this,

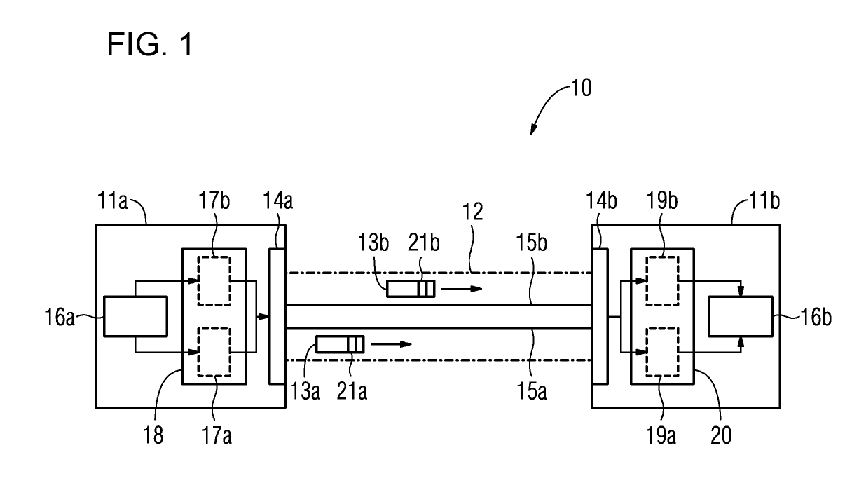

FIG. 1 shows a system of a transmitter and a receiver which are arranged for transmitting data telegrams between one another, and

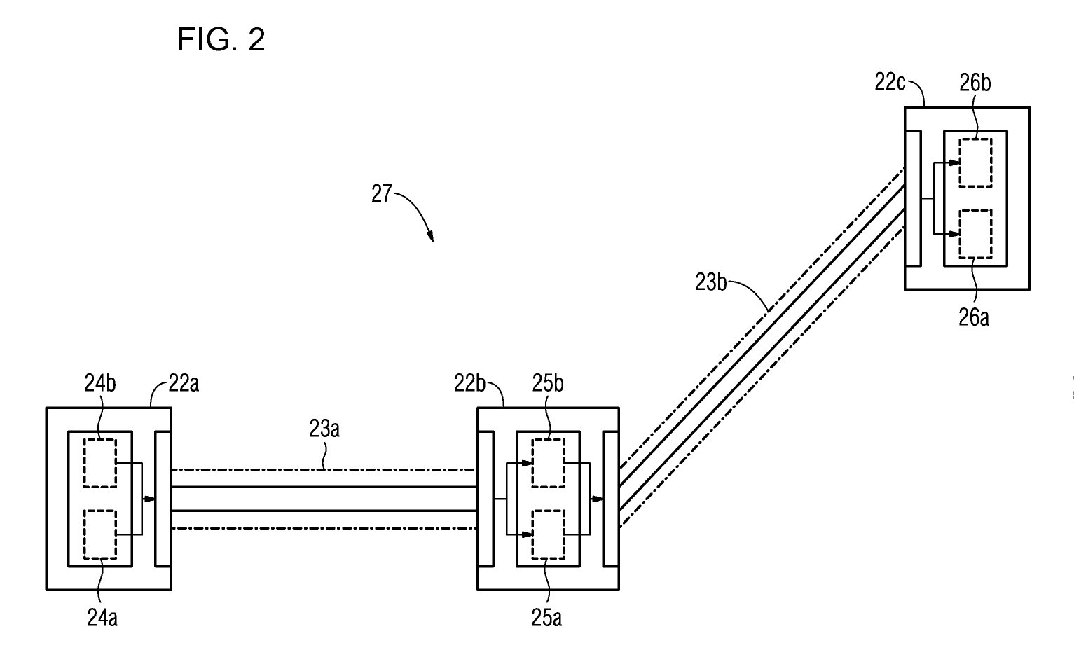

FIG. 2 shows a system of three electrical devices which are arranged for transmitting data telegrams between one another.

FIG. 1 shows a system 10 comprising a transmitter 11a and a receiver 11b between which a physical communication medium 12 is provided for transmitting data telegrams 13a, 13b. The transmitters and receivers 11a and 11b can be, for example, network-capable devices (e.g. personal computers, multimedia devices, servers, routers, switches) of a home or office network (possibly with additional Internet connection) or devices of an automation system, e.g. an energy automation system. The physical communication medium 12 can be a wire-connected medium, that is to say, for example, a copper line, a coaxial line or an optical fiber line, or a wireless communication link, for example a radio link according to the WLAN standard. The transmission of data telegrams can take place, for example, in accordance with the IP Protocol.

For the purpose of coupling to the physical communication medium 12, the transmitter 11a has an interface 14a and the receiver 11b has an interface 14b. The interfaces 14a and 14b are arranged in such a manner that with these, several logical data links can be established between the transmitter 11a and the receiver 11b via the single physical communication medium 12, of which data links a first logical data link 15a and a second logical data link 15b are shown by way of example in FIG. 1.

In addition, the transmitter 11a has a computing device 16a, for example a microprocessor (CPU) which, if necessary, apart from other functions—is arranged for generating messages which are to be transmitted as data telegrams 13a, 13b to the receiver 11b and are there to be processed further by a computing device 16b of the receiver 11b. In this context, the messages should comprise data contents of different importance. Messages with important data contents should be conveyed as data telegrams 13b with high priority to the receiver 11b whilst those data telegrams 13a having a lesser importance are intended to be conveyed with correspondingly lower priority to the receiver 11b. This ensures that the data telegrams 13b with important—since, for example, time-critical—data content are recognized as having high priority and are treated preferably both by the transmitter 11a and by the receiver 11b.

In order to be able to perform such a transmission of data telegrams having different priority levels as simply as possible and at high speed, the data processing device 16a places data telegrams 13a having a lower priority level into an intermediate storage area 17a of an intermediate memory 18, whilst those data telegrams 13b having a higher priority level are deposited in the intermediate storage area 17b of the intermediate memory 18.

In deviation from the representation according to FIG. 1 in which the intermediate storage areas 17a and 17b are arranged within the same physical intermediate memory 18, physical intermediate memories (that is to say, for example, two flash memory modules) which are separate from one another, can also be used as intermediate storage areas 17a and 17b; this also applies to the intermediate storage areas 19a and 19b of the receiver 11b, explained in greater detail below.

As long as only data telegrams 13a having a lower priority level are deposited by the data processing device 16a in the intermediate storage area 17a, they are arranged in the order in which they are deposited in a queue and are transferred successively to the interface 14a which initiates a sequential transmission of the data telegrams 13a having a lower priority level to the interface 14b of the receiver 11b via the logical data link 15a. The interface 14b of the receiver 11b recognizes that the data telegram 13a has been transmitted via the logical data link 15a having the lower priority level and deposits the received data telegram 13a in an intermediate storage area 19a of an intermediate memory 20 of the receiver 11b, this intermediate storage area 19a being reserved for data telegrams of lower priority level.

The data processing device 16b of the receiver 11b can thus take and process the data telegrams 13a, reserved in a further queue in the intermediate storage area 19a, successively from the intermediate storage area 19a, the data processing device 16b of the receiver 11b obtaining knowledge, merely due to the fact that the data telegram 13a has been deposited in the intermediate storage area 19a, about the fact that a lower priority level has been allocated to the data telegram 13a.

If the data processing device 16a of the transmitter 11a has generated a data telegram 13b having a very important data content, this is correspondingly allocated a high priority level and is deposited in the storage are 17b of the intermediate memory 18 by the data processing device 16a. Such a data telegram 13b of a higher priority level can be, for example, a message which specifies a fault detected by the transmitter 11a and must be forwarded immediately for evaluation to the data processing device 16b of the receiver 11b. For this purpose, the intermediate storage area 17b is monitored for the presence of a data telegram 13b by the interface 14a. As soon as the interface 14a detects that at least one data telegram 13b has been deposited in the intermediate storage area 17b, this data telegram 13b is conveyed to the interface 14b of the receiver 11b via the logical data link 15b of the higher priority level.

The interface 14b of the receiver 11b correspondingly deposits the data telegram 13b of the higher priority level in an intermediate storage area 19b of the data memory 20. The data processing device 16b detects that a data telegram 13b is received in the intermediate storage area 19b and takes it from the intermediate memory 20 preferably for further processing.

To ensure immediate transmission of the data telegram 13b of the higher priority level also when currently a data telegram 13a of the lower priority level is still being transmitted via the logical data link 15a, it can be provided, for example, that the transmission of the data telegram 13a of the lower priority level is immediately aborted when a data telegram 13b is deposited in the intermediate storage area 17b. The interface 14a preferably characterizes the data telegram 13a, transmitted incompletely in this case, as to be discarded by the receiving interface 14b. Such a data telegram 13a provided with a corresponding incompleteness marking is not even forwarded by the interface 14b of the receiver 11b to the intermediate storage area 19a in the intermediate memory 20 but discarded immediately on receipt. In this procedure, it is possible, due to the termination of the transmission of the data telegram 13a having the lower priority level, to begin immediately with the transmission of the data telegram 13b of the higher priority level via the physical data link 15b so that no delay occurs in the transmission of the high-priority data telegram 13b.

As soon as the data telegram 13b—and possibly other high-priority data telegrams still present in the intermediate storage area 17b—have been transmitted, the interface 14a continues the transmission of the low-priority data telegrams from the intermediate storage area 17a beginning with that data telegram, the transmission of which has previously been aborted. In this manner, it is possible to achieve that no loss of low-priority data telegrams occurs even in the case of a termination of the transmission.

As an alternative, it can also be provided that initially the complete transmission of the low-priority data telegram 13a via the logical data link 15a is awaited instead of immediately aborting its transmission. It is only after that that the high-priority data telegram 13b is transmitted via the logical data link 15b. In this case, a slight delay of the transmission of high-priority data telegrams must be accepted.

The priority level can be specified in a particularly simple manner for the individual data telegrams 13a or 13b, respectively due to the fact that different destination addresses of the receiver 11b are allocated in the data telegrams 13a and 13b, respectively. Such different destination addresses are represented diagrammatically in FIG. 1 as rectangles 21a (destination address of the lower priority level) and 21b (destination address of the higher priority level). Such destination addresses can be, for example, mutually different MAC addresses of the receiver 11b. In this context, no separate entry needs to be made in the data telegram 13a and 13b, respectively, for identifying the priority level apart from the destination address to be entered in any case.

In order to be able to perform a comparatively inexpensive distribution of the destination addresses of the individual priority levels especially in systems which are used for transmitting data telegrams having more than two priority levels, it can be provided that the destination addresses allocated to the respective priority levels can be derived from one another in accordance with a predetermined rule. For example, it can be provided that the destination address consists of a first area which specifies the respective receiver, for example receiver 11b, and a suffix, for example consecutive numbering, is appended to the first area, an increase in priority level being associated with an increasing value of the numbering (for example suffix “01”: lowest priority, suffix “02”: medium priority, suffice “03”: highest priority). If the transmitter 11a knows the destination address of the receiver 11b, to be used for data telegrams of the lowest priority, it can derive from this, knowing the corresponding rule, the destination addresses for the remaining priority levels without problems in each case without this having to be conveyed separately to the transmitter 11a or, in the case of parameterizing, as an entry therein.

Although FIG. 1 talks of a transmitter 11a and a receiver 11b for the purpose of simpler illustration, the transmission of the data telegrams via the physical communication medium 12 can be bidirectional, that is to say in both directions, so that both the transmitter 11a and the receiver 11b can pose in each case as transmitter and as receiver of the data telegrams 13a, 13b.

Furthermore, instead of the two priority levels assumed in the description of FIG. 1, further priority levels can actually also be used and the procedure described is then adapted to the corresponding number of existing priority levels.

FIG. 2 shows a system 27 consisting of three electrical devices which, according to the present illustrative embodiment, are intended to be automation devices of an energy automation system. For this purpose, the system 27 has an electrical protective device 22a for monitoring a primary component of an electrical energy supply system, not shown (for example an overhead line or a transformer), a station control unit 22b and a data processing device 22c of a power system control center. The station control unit 22b is connected, on the one hand, to the protective device 22a via the physical communication medium 23a (for example a station bus) and, on the other hand, via the physical communication medium 23b to the data processing device 22c of the power system control center.

Although the physical communication media 23a and 23b are represented as mutually separate physical communication media in FIG. 2, they can also be the same physical communication medium, for example if all devices 22a, 22b, 22c are connected to a common communication network. Apart from the devices 22a, 22b, 22c, the system 27 can also comprise other devices, not shown, however, for the sake of clarity in FIG. 2.

The protective device 22a generates data telegrams having a lower priority level and deposits these in an intermediate storage area 24a, whereas data telegrams having a higher priority level, generated by the electrical protective device 22a, are deposited in an intermediate storage area 24b. As explained thoroughly in conjunction with FIG. 1, a transmission takes place to the station control unit 22b via the corresponding logical data links which are set up on the physical communication medium 23a in dependence on the priority level of the respective data telegram—that is to say in dependence on the storage area 24a or 24b in which the respective data telegrams are deposited.

Data telegrams of lower priority level received by the station control unit 22b are deposited in an intermediate memory 25a, whereas data telegrams having a higher priority are deposited in an intermediate memory 25b.

Messages of a lower priority level, generated in an energy automation system, can be, for example, measurement values with respect to the quality of the electrical energy, so-called fault records (tracings of measurement values which have been recorded during a fault), statistical data, sets of parameters and similar data, whereas messages of a higher priority level are, for example, messages specifying a fault in the electrical power supply system or measurement values to be processed further immediately. In an energy automation system which is operated according to the IEC 61850 standard with regard to their communication there can be such higher-priority messages, for example so-called GOOSE telegrams (Generic Object Oriented Substation Events) or sampled measured values to be transmitted with high priority.

The station control unit 22b can supply the corresponding data telegrams, for example, to independent data processing, e.g. to an evaluation or an indication of the data content of the respective data telegrams. In this context, it takes into consideration—as already explained with reference to FIG. 1—the priority level of the respective data telegram recognizable from the respective intermediate storage area 25a, 25b.

As an alternative or additionally, forwarding to the data processing device 22c of the power system control center can also be provided with regard to some data telegrams. In such a case, the station control unit 22b virtually takes over, on the one hand, the role of a receiver for the data telegrams transmitted by the protective device 22a to the station control unit 22b and, on the other hand, the role of a transmitter for those data telegrams which are forwarded by the station control unit 22b to the data processing device 22c of the power system control center.

In consequence, the station control unit 22b, taking into consideration the priority level specified by the respective intermediate storage area 25a, 25b, transfers the respective data telegrams via the corresponding logical data links of the physical communication medium 23b to the data processing device 22c of the power system control center which, in this case, takes over the role of the receiver according to FIG. 1 and deposits the received data telegrams in corresponding intermediate storage areas 26a (for low-priority data telegrams) and 26b (for high-priority data telegrams).

The deposited data telegrams are supplied to a computing device (CPU), not shown in FIG. 2, of the data processing device 22c of the power system control center which then carries out further data processing with respect to the received data telegrams, for example in order to present the content of the data telegrams to the control center personnel in the form of tables and/or diagrams or to perform automatic evaluations with regard to the content of the data telegrams.

Although only one direction of data transmission from the protective device 22a via the station control unit 22b to the data processing device 22c of the power system control center has been explained in FIG. 2, the communication of the data telegrams can also take place in the reverse direction so that the transmission media 23a and 23b are designed for bidirectional data transmission. For example, low-priority parameterizing data or high-priority control commands can be transmitted in this manner from the data processing device 22c of the power system control center to the station control unit 22b and/or the protective device 22a in accordance with their respective priority level.

At the start-up of a system in which the individual devices do not yet have any knowledge about the destination addresses of the respectively other devices, to be used for the various priority levels, it can be advantageously provided that at least one device sends a so-called broadcast message to the destination address defined throughout the system for the purpose of address distribution (for example the MAC address 0xFFFFFFFFFFFFF). A broadcast message is a message without predefined circle of receivers which is conveyed to all devices connected to the physical communication medium. This destination address defined throughout the system is allocated to a particular priority level, for example the lowest priority level. Each receiver of the broadcast message takes from the broadcast message the sender address, also entered, of the device sending the broadcast message and uses this sender address from then on as destination address for conveying the data telegrams of lowest priority level to the sender.

In as much as the destination addresses of the individual priority levels are dependent on one another, as explained above, the receivers of the broadcast message can derive from the destination address for the lowest priority level, now known, the destination addresses to be used for all other priority levels.

The systems 10 and 27 shown in FIGS. 1 and 2 ensure fast and reliable transmission of data telegrams of high priority and a reliable transmission of data telegrams of lower priority. By setting up individual logical data links via the existing physical communication media and permanently allocating logical data links to individual priority levels, the respective priority level of the individual data telegrams can be identified by using in each case different destination addresses, for example, at the lowest level of the OSI layer model. By this means, the proposed method can be kept very simple and still reliable overall since, for example, at higher levels of the OSI layer model no further computing capacity of the individual electrical devices is needed for specifying or determining the priorities of the individual data telegrams.

1-10. (canceled)

11. A method of transmitting data telegrams from a transmitter to at least one receiver through a physical communication medium connected between the transmitter and the receiver, the method which comprises:
associating a priority level with the data telegrams to be transmitted, the priority level specifying a priority to be taken into consideration in a transmission of the respective data telegram such that data telegrams having a higher priority level compared with data telegrams having a lower priority level are transmitted with preference over the data telegrams having the lower priority level from the transmitter to the receiver;
providing in the transmitter an intermediate storage area associated with each priority level;
transmitting the data telegrams via the physical communication medium through different logical data links, wherein a number of the logical data links corresponds to a number of priority levels;
transmitting those data telegrams present in a respective intermediate storage area associated with a lower priority level via the logical data link associated with the lower priority level for such a time until at least one data telegram is present in a respective intermediate storage area associated with a higher priority level; and
thereupon transmitting the data telegram present in the intermediate storage area associated with the higher priority level via the logical data link associated with the higher priority level.

12. The method according to claim 11, which comprises aborting a current transmission of a data telegram via the logical data link associated with the lower priority level as soon as a data telegram is present in the intermediate storage area associated with the higher priority level.

13. The method according to claim 12, which comprises adding an identification marking the data telegram as to be discarded by the receiver to an incompletely transmitted data telegram due to a termination of transmission.

14. The method according to claim 12, which comprises repeating a transmission of the data telegram transmitted incompletely after a last data telegram currently present in the intermediate storage area associated with the higher priority level has been transmitted.

15. The method according to claim 11, which comprises first concluding a current transmission of a data telegram via the logical data link associated with the lower priority level before the data telegram present in the intermediate storage area associated with the higher priority level is transmitted via the logical data link associated with the higher priority level.

16. The method according to claim 11, which comprises specifying the priority level for the respective data telegram by way of a destination address of the receiver.

17. The method according to claim 16, which comprises determining the destination addresses used for the different priority levels in accordance with a specified rule so that, knowing a destination address that is associated with a particular priority level, all destination addresses of the remaining priority levels can be derived from the known destination address.

18. The method according to claim 11, which comprises:
for a start-up of a system of devices including at least one transmitter and at least one receiver, sending a broadcast message with at least one of the devices to a destination address defined throughout the system, the destination address being associated with a particular priority level; and
gathering, with a respective device receiving the broadcast message, a sender address from the broadcast message, the sender address specifying the sender of the broadcast message, and using the sender address from then on as destination address for the priority level, allocated to the sender.

19. An electrical device, comprising:
a communication interface for establishing a communication link via a physical communication medium to at least one further electrical device, said physical communication medium being configured for transmitting data telegrams between the electrical device and the at least one further electrical device, said communication interface being configured for establishing at least two logical data links via said physical communication medium, each said logical data link having a different priority level allocated thereto; and
the electrical device being configured for transmitting the data telegrams in accordance with the method according to claim 11.

20. The electrical device according to claim 19, configured as an automation device of an energy automation system.

21. The electrical device according to claim 20, wherein said automation device is a device selected from the group consisting of an electrical protective device, an electrical field control unit, a station control unit, a device of an electrical power system control center, and a communication device in an energy automation system.
